(19) United States
(12) Patent Application Publication
(10) Pub. No.: US 2025/0016148 A1
(43) Pub. Date: Jan. 9, 2025

(54) CERTIFICATE MANAGEMENT IN REMOTE COLLECTORS WITH HIGH AVAILABILITY

(71) Applicant: VMware LLC, Palo Alto, CA (US)

(72) Inventors: Venkata PADMA Kaki, West Godavari (IN); Rahul Singh, Bangalore (IN); Vinothkumar D, Villupuram District (IN); Vineeth Totappanavar, Bangalore (IN); Aswathy Ramabhadran, Bangalore (IN)

(21) Appl. No.: 18/244,323

(22) Filed: Sep. 11, 2023

(30) Foreign Application Priority Data
Jul. 7, 2023 (IN) 202341045741

(51) Int. Cl. H04L 9/40; G06F 11/30; H04L 41/0663; H04L 67/1008; H04L 67/56

(52) U.S. Cl. CPC H04L 63/0823; G06F 11/3006; H04L 41/0663; H04L 67/1008; H04L 67/56

(57) ABSTRACT

The system includes a first endpoint and a second endpoint executing a remote collector to receive metrics from the first endpoint using a first CA certificate of the remote collector. Further, the system includes a storage device to store a second CA certificate for a collector group that shares responsibility for a monitoring function to support high availability and a management node including a certificate management module. The certificate management module may add the second endpoint to the collector group in response to receiving a request. Further, the certificate management module may retrieve the second CA certificate from the storage device and replace the first CA certificate of the remote collector with the second CA certificate of the collector group. Furthermore, the certificate management module may enable the collector group to validate a request to accept the metrics from the first endpoint based on the second CA certificate.

### RELATED APPLICATIONS

Benefit is claimed under 35 U.S.C. 119(a)-(d) to Foreign Application Serial No. 202341045741 filed in India entitled “CERTIFICATE MANAGEMENT IN REMOTE COLLECTORS WITH HIGH AVAILABILITY”, on Jul. 7, 2023, by VMware, Inc., which is herein incorporated in its entirety by reference for all purposes.

### TECHNICAL FIELD

The present disclosure relates to computing environments, and more particularly to methods, techniques, and systems for managing certificates in remote collectors with high availability in a computing environment.

### BACKGROUND

In application/operating system (OS) monitoring environments, a management node that runs a monitoring tool (i.e., a monitoring application) may communicate with multiple endpoints (e.g., virtual computing instances (VCIs)) to monitor the endpoints via a remote collector (e.g., a cloud proxy). For example, an endpoint may be implemented in a physical computing environment, a virtual computing environment, or a cloud computing environment. Further, the endpoints may execute different applications via virtual machines (VMs), physical host computing systems, containers, and the like. In such environments, the endpoints may send performance data/metrics (e.g., application metrics, operating system metrics, and the like) from underlying operating system and/or services to the remote collector. Further, the remote collector may provide the performance metrics to the monitoring tool for storage and performance analysis (e.g., to detect and diagnose issues).

### BRIEF DESCRIPTION OF THE DRAWINGS

FIG. 1A is a block diagram of an example system, depicting a management node to manage certificates in a remote collector with high availability;

FIG. 1B is a block diagram of example system of FIG. 1A, depicting a collector group when the remote collector is added to the collector group;

FIG. 2 is a sequence diagram illustrating an example sequence of events to manage certificates of remote collectors when the remote collectors are added to a collector group;

FIG. 3 is a flow diagram illustrating an example method for updating a certificate authority (CA) certificate of a first remote collector when the first remote collector is added to a collector group; and

FIG. 4 is a block diagram of an example management node including non-transitory computer-readable storage medium storing instructions to generate a CA certificate for a collector group when a remote collector is added to the collector group.

The drawings described herein are for illustrative purposes and are not intended to limit the scope of the present subject matter in any way.

### DETAILED DESCRIPTION

Examples described herein may provide an enhanced computer-based and/or network-based method, technique, and system to manage certificates in remote collectors with high availability in a computing environment. The paragraphs [0010] to [0019] present an overview of the computing environment, existing methods to manage certificates in remote collectors, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., a central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

Further, performance monitoring of the endpoints has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), VMware Wavefront™, Grafana, and the like. Such performance monitoring tools may be used to monitor a datacentre on a private, public, and/or hybrid cloud.

In some examples, the endpoints may include monitoring agents (e.g., Telegraf™, Collectd, Micrometer, and the like) to collect the performance metrics from the respective endpoints and provide, via a network, the collected performance metrics to a remote collector (e.g., a Cloud Proxy (CP)). For example, a monitoring agent such as Telegraf™ agent running in an endpoint may collect metrics from the endpoint and publish them to a metrics receiver. In this example, an Apache HTTPD server serves as the metrics receiver in the CP. The Apache HTTPD server running in the CP may listen on a specific location directive on port 443 to receive the metrics from the Telegraf™ agent.

Further, the remote collector may receive the performance metrics from the monitoring agents and transmit the performance metrics to a monitoring tool or a monitoring application for metric analysis. A remote collector may refer to a service/program that is installed in an additional cluster node (e.g., a virtual machine). The remote collector may allow the monitoring application (e.g., vROps Manager) to gather objects into the remote collector's inventory for monitoring purposes. The remote collector collects the data from the endpoints and then forward the data to an application monitoring server that executes the monitoring application. For example, remote collectors may be deployed at remote location sites while the monitoring tool may be deployed at a primary location. In an example, vROps is a multi-node application that can monitor geographically distributed datacentres. In such a distributed environment, remote collectors are installed at each geo location to monitor and control endpoints at respective datacentres. These remote collectors act as communication medium between master node (i.e., the monitoring application) and the datacentre. Furthermore, the monitoring application may receive the performance metrics, analyse the received performance metrics, and display the analysis in a form of dashboards, for instance. The displayed analysis may facilitate in visualizing the performance metrics and diagnose a root cause of issues, if any.

In such examples, the monitoring application (e.g., vROps) may use the remote collector (e.g., a cloud proxy) to support application and operating system monitoring. The cloud proxy may install the agents on the endpoints to monitor applications and an operating system running in the endpoints. For example, the agents installed on the endpoints may include a monitoring agent (e.g., Telegraf™), a supporting agent (e.g., UCP-minion), and a configuration agent (e.g., salt-minion). In an example software-as-a-service (SaaS) platform, the cloud proxy includes a data plane provided by an Apache HTTPD web server via hypertext transfer protocol secure (HTTPS) protocol and a control plane provided via Salt. In such an example SaaS platform, each endpoint may host the monitoring agent (e.g., Telegraf Agent) for posting application and operating system metrics to the remote collector, the supporting agent for posting service discovery and health metrics to the remote collector, and the configuration agent for receiving control actions/commands from the remote collector. Further, the Telegraf agent and the UCP minion of the data plane may publish metrics to the Apache HTTPD web server running in the cloud proxy. Furthermore, the Salt minion of the control plane may communicate with the Salt master running in the remote collector. Further, control commands such as updating the agents, starting/stopping the agents, and the like may be performed via the Salt minions upon the request of the Salt master.

The remote collector may use Apache httpd service for data plane. The Apache httpd service may use certificate-based authentication for metrics being posted at the cloud proxy. In this example, as part of agent installation at the endpoint, client certificates or client authentication certificates (e.g., OpenSSL certificate) are placed at the endpoint. Client authentication for metrics being posted from the endpoints to the remote collector is being done by using remote collector's Certificate Authority (CA) certificate and the client certificates placed at the endpoints during agent install operation.

Further, the remote collector (e.g., the cloud proxy) may support high availability for application monitoring by deploying at least two remote collectors and linking them with a collector group. The collector group may be a virtual entity that allows the remote collectors to be grouped together. For example, cloud proxies may provide high availability within the cloud environment, in which two or more cloud proxies are grouped to form the collector group. The cloud proxy collector group may ensure that there is no single point of failure in the cloud environment. If one of the cloud proxies experiences a network interruption or becomes unavailable, the other cloud proxy from the collector group takes charge and ensures that there is no downtime. In the example of cloud proxy collector group, a “KeepaliveD” service may be utilized at the remote collector to support high availability within the collector group. The “KeepaliveD” service is a framework for both load balancing and high availability that implements a virtual router redundancy protocol (VRRP). The VRRP creates a virtual IP (or VIP, or floating IP) that acts as a gateway to route traffic from the monitored endpoints.

For example, when the cloud proxy belongs to the collector group, the KeepaliveD service acts as a receiver of the metrics from the endpoints being monitored by the cloud proxy. When the cloud proxy is not a member of the collector group, the Apache httpd service may be utilized to receive the metrics from the cloud proxy.

In the existing architecture, the remote collector can move-in or move-out of the collector group. In such a scenario, depending on whether the remote collector is a member of the collector group or not, the agents (e.g., the monitoring agent, the supporting agent, and the like) installed in the endpoints may have to be modified to post metrics to either the Apache httpd service or the KeepaliveD service.

The CA certificate is generated during a first bootstrap of the remote collector and the generated CA certificate may be used by httpd-south configuration to validate client requests to accept performance metric data. During the agent (e.g., the monitoring agent and the supporting agent) installation in the endpoint, the client certificate for the endpoint may be generated using the remote collector's CA certificate and is pushed to the endpoint to be used by the monitoring agent and the supporting agent while posting the performance metrics to the remote collector. If the collector group is used to accomplish high availability of application monitoring, in case of failover, the endpoint may fail to communicate to the next available remote collector in the collector group because the CA certificate differs from one remote collector to another remote collector, and the client certificate validation may not work with different remote collectors. Therefore, the cloud proxies in the collector group may have to share the same server (e.g., the cloud proxy) CA certificate to support a high-availability or load balancing operation.

Examples described herein may provide a management node to manage certificates in remote collectors with high availability. In an example, the management node may generate a collector group that supports a high availability operation. The collector group may include a first remote collector to receive metrics from a first endpoint and a second remote collector to receive metrics from a second endpoint. Further, the management node may generate a CA certificate for the collector group. Furthermore, the management node may assign the CA certificate to the first remote collector and the second remote collector. Upon assigning the CA certificate, the management node may enable the collector group to validate a request to accept metrics from the first endpoint and the second endpoint based on the CA certificate.

Thus, examples described herein may provide an approach to manage the certificates of the remote collectors in the collector group for application monitoring in case of high availability, load-balance, and the like. Further, this approach can withstand failure scenarios as the data may now be able to flow to another remote collector in the collector group without any intervention. Also, examples described herein may address the security concern for the remote collectors as the CA certificate is generated for each collector group.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

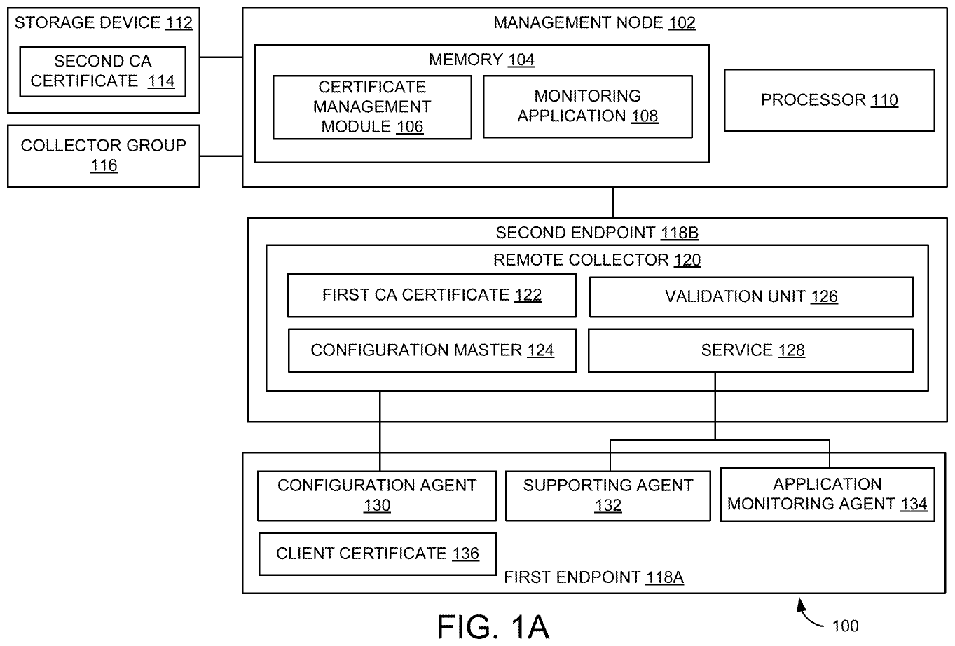

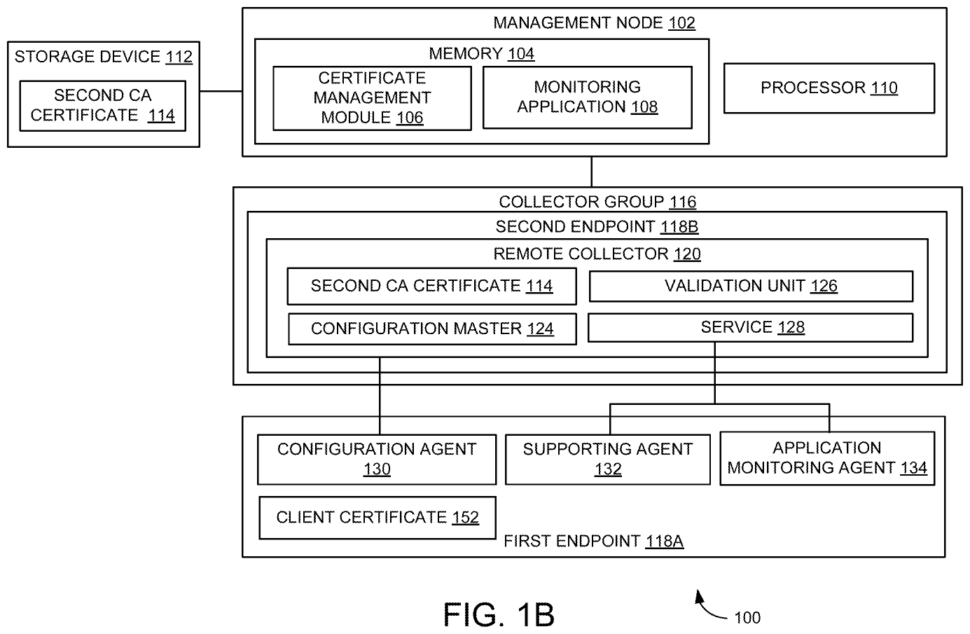

Referring now to the figures, FIG. 1A is a block diagram of an example system 100, depicting a management node 102 to manage certificates in a remote collector (e.g., a remote collector 120) with high availability. Example system 100 may include a computing environment such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

For example, system 100 may be a data center that includes multiple endpoints 118A and 118B. In an example, an endpoint may include, but not limited to, a virtual machine, a physical host computing system, a container, a software defined data center (SDDC), or any other computing instance that executes different applications. The endpoint can be deployed either on an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. An example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of the host's operating system without the need for the hypervisor or separate operating system.

Further, first endpoint 118A may include an application monitoring agent 134 to monitor applications, services, and/or programs running in endpoint 118A. In an example, application monitoring agent 134 may be installed in first endpoint 118A to fetch the metrics from various components of first endpoint 118A. For example, application monitoring agent 134 may real-time monitor first endpoint 118A to collect the metrics (e.g., telemetry data) associated with an application or an operating system running in first endpoint 118A. Example application monitoring agent 134 may be Telegraf agent, Collectd agent, or the like. Example metrics may include performance metric values associated with at least one of central processing unit (CPU), memory, storage, graphics, network traffic, applications, or the like.

Furthermore, first endpoint 118A may include a supporting agent 132 (e.g., a UCP-minion) and a configuration agent 130 (e.g., a salt-minion). For example, supporting agent 132 may obtain service discovery metrics including a list of services running in first endpoint 118A, health metrics of application monitoring agent 134, or a combination thereof. Further, configuration agent 130 may receive control commands from a configuration master 124 of remote collector 120. For example, configuration master 124 may run as part of a docker container on second endpoint 118B that executes remote collector 120. Thus, remote collector 120 may perform the control commands such as updating the agents, starting/stopping the agents, and the like on first endpoint 118A via configuration agent 130.

As shown in FIG. 1A, second endpoint 118B may include remote collector 120. Further, system 100 may include a collector group 116, i.e., a virtual entity that allows the remote collectors to be grouped together to provide high availability. For example, remote collector 120 may be a cloud proxy to communicate with a monitoring application 108. Consider that remote collector 120 is not part of collector group 116. In this example, application monitoring agent 134 and supporting agent 132 of first endpoint 118A may publish metrics to a service 128 (e.g., an Apache httpd service) at remote collector 120. During operation, second endpoint 118B executing remote collector 120 may use service 128 to collect metrics of first endpoint 118A based on a client certificate 136. In an example, client certificate 136 may be generated for first endpoint 118A using a first Certificate Authority (CA) certificate 122 of remote collector 120. Further, remote collector 120 may send the received metrics to monitoring application 108. Furthermore, monitoring application 108 may analyse the received metrics to detect and diagnose issues associated with first endpoint 118A.

In an example, remote collector 120 may include a validation unit 126 to establish a communication between first endpoint 118A and remote collector 120 based on client certificate 136. Upon establishing the communication, validation unit 126 may enable service 128 to receive the performance metrics from first endpoint 118A.

In some examples, first endpoint 118A, second endpoint 118B, and management node 102 may be communicatively connected via a network. An example network can be a managed Internet protocol (IP) network administered by a service provider. For example, the network may be implemented using wireless protocols and technologies, such as Wi-Fi, WiMAX, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

In an example, system 100 may include a storage device 112 to store a second CA certificate 114 for collector group 116 that shares responsibility for a monitoring function to support high availability. In an example, the monitoring function that supports high availability for collector group 116 may be a high availability failover operation. In the high availability failover operation, if one of the remote collectors (e.g., cloud proxies) experiences a network interruption or becomes unavailable, the other remote collector from the collector group takes charge and ensures that there is no downtime. In another example, the monitoring function that supports high availability for collector group 116 may be a load balancing operation. The load balancing operation may refer to a process of distributing the incoming metrics from the endpoints (e.g., first endpoint 118A) among remote collectors in collector group 116.

During a process of creating collector group 116, second CA certificate 114 for collector group 116 is generated at management node (e.g., vROps cluster node) and the same is distributed to all remote collectors (e.g., cloud proxies) in collector group 116. In an example, second CA certificate 114 is stored in storage device 112 using an associated collector group identifier.

As shown in FIG. 1A, management node 102 may include a processor 110. Processor 110 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 110 may, for example, include single or multiple cores on a chip, multiple cores across multiple chips, multiple cores across multiple devices, or suitable combinations thereof. Processor 110 may be functional to fetch, decode, and execute instructions as described herein. Further, management node 102 includes memory 104 coupled to processor 110. In an example, memory 104 may include a certificate management module 106 and monitoring application 108. Furthermore, processor 110 may execute certificate management module 106 and monitoring application 108 stored in memory 104. In the example shown in FIG. 1, certificate management module 106 and monitoring application 108 are implemented as part of management node 102, however, in other examples, certificate management module 106 and monitoring application 108 can be implemented in different nodes.

Consider that remote collector 120 is not part of collector group 116. During operation, certificate management module 106 may receive a request to add second endpoint 118B to collector group 116. In response to receiving the request, certificate management module 106 may add second endpoint 118B to collector group 116. Further, certificate management module 106 may retrieve second CA certificate 114 from storage device 112, for instance, using the collector group identifier.

Further, certificate management module 106 may replace first CA certificate 122 of remote collector 120 with second CA certificate 114 of collector group 116. In an example, certificate management module 106 may restart service 128 running in remote collector 120 using second CA certificate 114 to enable collector group 116 to validate the request to accept the metrics from first endpoint 118A. Furthermore, certificate management module 106 may enable collector group 116 to validate a request to accept the metrics from first endpoint 118A based on second CA certificate 114. In an example, certificate management module 106 may enable one of remote collectors of collector group 116 that acts as a master to validate the request to accept the metrics from an agent (e.g., application monitoring agent 134 and supporting agent 132) running in first endpoint 118A based on second CA certificate 114.

FIG. 1B is a block diagram of example system 100 of FIG. 1A, depicting collector group 116 when remote collector 120 is added to collector group 116. For example, similarly named elements of FIG. 1B may be similar in structure and/or function to elements described with respect to FIG. 1A. For example, when remote collector 120 is added to collector group 116, one of remote collectors in collector group 116 may function as a master remote collector and remaining remote collectors in collector group 116 may function as standby remote collectors.

In an example, when remote collector 120 is added to collector group 116, second CA certificate 114 of collector group 116 is used to generate a client certificate 152 for first endpoint 118A. In this example, client certificate 136 of first endpoint 118A (e.g., as shown in FIG. 1A) is replaced with client certificate 152 (e.g., as shown in FIG. 1B). Further, client certificate 152 may be used by first endpoint 118A to post the metrics to collector group 116.

In this example, validation unit 126 may establish a communication between first endpoint 118A and remote collector 120 based on client certificate 152 and second CA certificate 114. Upon establishing the communication, certificate management module 106 may enable service 128 to receive the performance metrics from first endpoint 118A.

In some examples, the functionalities described in FIGS. 1A and 1B, in relation to instructions to implement functions of certificate management module 106, validation unit 126 and any additional instructions described herein in relation to the storage medium, may be implemented as engines or modules including any combination of hardware and programming to implement the functionalities of the modules or engines described herein. The functions of certificate management module 106 and validation unit 126 may also be implemented by respective processors. In examples described herein, each processor may include, for example, one processor or multiple processors included in a single device or distributed across multiple devices.

Further, the cloud computing environment illustrated in FIGS. 1A and 1B are shown purely for purposes of illustration and is not intended to be in any way inclusive or limiting to the embodiments that are described herein. For example, a typical cloud computing environment would include many more remote servers (e.g., endpoints), which may be distributed over multiple data centers, which might include many other types of devices, such as switches, power supplies, cooling systems, environmental controls, and the like, which are not illustrated herein. It will be apparent to one of ordinary skill in the art that the example shown in FIGS. 1A and 1B, as well as all other figures in this disclosure have been simplified for ease of understanding and are not intended to be exhaustive or limiting to the scope of the idea.

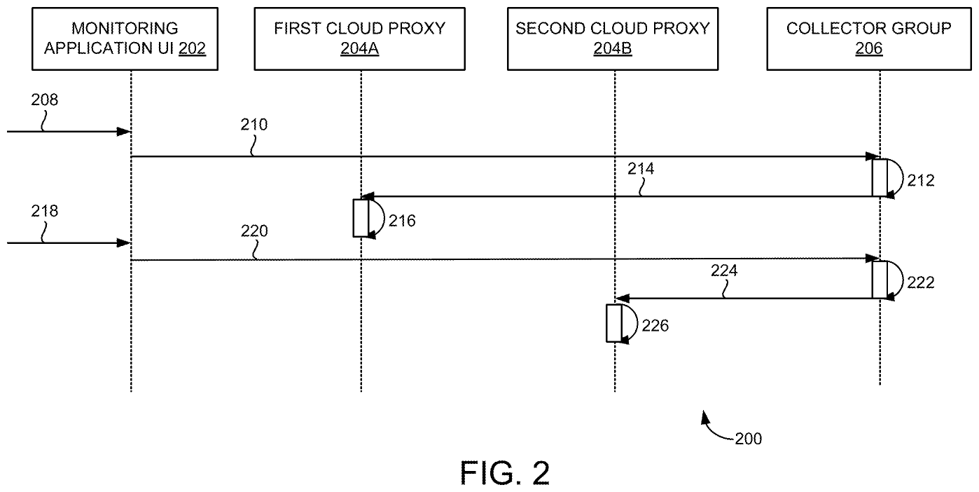

FIG. 2 is a sequence diagram 200 illustrating an example sequence of events to manage certificates of remote collectors (e.g., a first cloud proxy 204A and a second cloud proxy 204B) when the remote collectors are added to a collector group 206. Sequence diagram 200 may represent the interactions and the operations involved in managing certificates of remote collectors (e.g., first cloud proxy 204A and second cloud proxy 204B). FIG. 2 illustrates process objects including a monitoring application user interface (UI) 202 (e.g., UI of vROps), first cloud proxy 204A, second cloud proxy 204B, and collector group 206 along with their respective vertical lines originating from them. The vertical lines of monitoring application UI 202, first cloud proxy 204A, second cloud proxy 204B, and collector group 206 may represent the processes that may exist simultaneously. The horizontal arrows (e.g., 208, 210, 214, 218, 220, and 224) may represent the data flow steps between the vertical lines originating from their respective process objects (for e.g., monitoring application UI 202, first cloud proxy 204A, second cloud proxy 204B, and collector group 206). Further, activation boxes (e.g., 212, 216, 222, and 226) between the horizontal arrows may represent the process that is being performed in the respective process object.

At 208, user interface of monitoring application 202 may receive a request to add first cloud proxy 204A to collector group 206. At 210, monitoring application 202 may add first cloud proxy 204A to collector group 206. At 212, a CA certificate for collector group 206 may be generated and stored in a storage device associated with the monitoring application. Further at 214, a certificate of first cloud proxy 204A may be replaced by generated CA certificate. At 216, a service (e.g., a httpd-south service) may be restarted at first cloud proxy 204A using the CA certificate.

At 218, the user interface of monitoring application 202 may receive a request to add second cloud proxy 204B to collector group 206. At 220, monitoring application 202 may add second cloud proxy 204B to collector group 206. At 222, collector group 206 may retrieve the CA certificate from the storage device. Further at 224, a certificate of second cloud proxy 204B may be replaced by retrieved CA certificate. At 226, a service (e.g., a httpd-south service) may be restarted at second cloud proxy 204B using the CA certificate.

Thus, when a cloud proxy is added to the collector group and when the collector group is created for the first time, then the CA certificate may be generated at the collector group. Further, the generated CA certificate may be maintained or stored using a collector group identifier. Furthermore, the generated CA certificate may be updated in the cloud proxy. In another example, when a cloud proxy is added to the existing collector group, the stored CA certificate may be retrieved using the collector group identifier and updated in the cloud proxy. Furthermore, a service may be restarted with the new CA certificates in the cloud proxies to receive metrics from the corresponding endpoints.

Examples described herein may resolve communication issues in two different use cases such as a high availability in failover mode and a high availability in load-balancing and failover mode. In failover mode, the remote collector may offer resistance against the failure of the services in a data-plane path. In load-balancing and failover mode, the remote collector may offer resistance against the failure of the services in the data plane. Further, a load-balancing component such as ‘HAProxy’ may provide metric data load-balanced. The ‘HAProxy’ may distribute the data among all available HTTPD/controller services on the remote collectors in the collector group. This mode may also facilitate to horizontally scale the remote collector components.

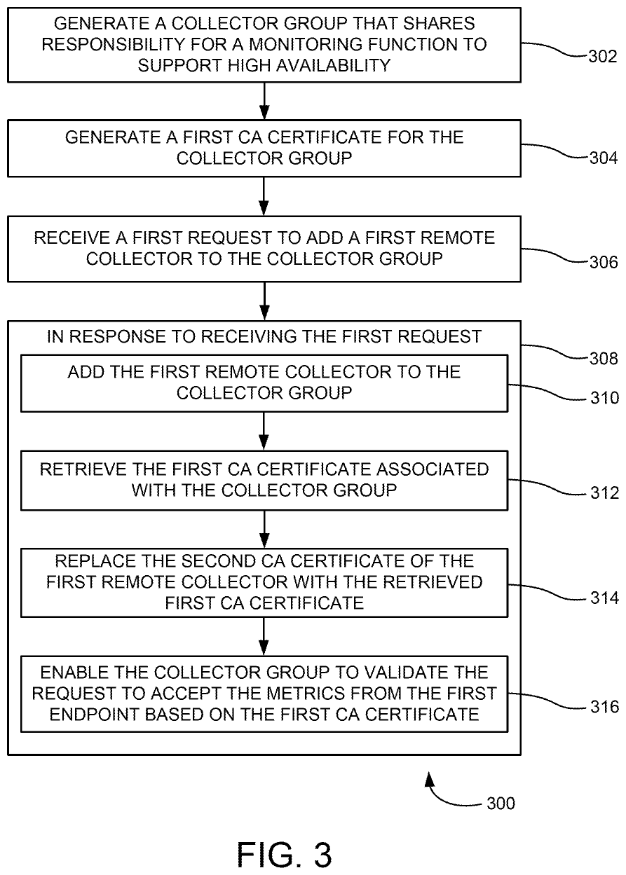

FIG. 3 is a flow diagram illustrating an example method 300 for updating a certificate authority (CA) certificate of a first remote collector when the first remote collector is added to a collector group. Example method 300 depicted in FIG. 3 represents generalized illustrations, and other processes may be added, or existing processes may be removed, modified, or rearranged without departing from the scope and spirit of the present application. In addition, method 300 may represent instructions stored on a computer-readable storage medium that, when executed, may cause a processor to respond, to perform actions, to change states, and/or to make decisions. Alternatively, method 300 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 302, a collector group that shares responsibility for a monitoring function to support high availability may be generated. In an example, the monitoring function that supports high availability for the collector group is a high availability failover operation, a load balancing operation, or a combination thereof.

At 304, a first certificate authority (CA) certificate may be generated for the collector group. At 306, a first request to add a first remote collector to the collector group may be received. In an example, the first remote collector may validate a request to accept metrics from a first endpoint based on a second CA certificate.

At 308, in response to receiving the first request, the processes in blocks 310, 312, 314, and 316 may be executed. At 310, the first remote collector may be added to the collector group. Further at 312, the first CA certificate associated with the collector group may be retrieved.

At 314, the second CA certificate of the first remote collector may be replaced with the retrieved first CA certificate. At 316, the collector group may be enabled to validate the request to accept the metrics from the first endpoint based on the first CA certificate. In an example, enabling the collector group to validate the request to accept the metrics from the first endpoint may include restarting a service running in the remote collector using the first CA certificate to enable the collector group to validate the request to accept metrics from the first endpoint.

In an example, a client certificate for the first endpoint may be generated using the first CA certificate of the collector group. The client certificate may be used by the first endpoint to post the metrics to the collector group.

Further, example method 300 may include receiving a second request to add a second remote collector to the collector group. The second remote collector may validate a request to accept metrics from a second endpoint based on a third CA certificate.

In response to receiving the second request, the second remote collector may be added to the collector group. Further, the first CA certificate associated with the collector group may be retrieved. Furthermore, the third CA certificate of the second remote collector may be replaced with the retrieved first CA certificate. Further, the collector group may be enabled to validate a request to accept the metrics from the second endpoint based on the retrieved first CA certificate.

In an example, enabling the collector group to validate the request to accept the metrics from the first endpoint and the second endpoint may include enabling one of the first remote collector and the second remote collector of the collector group that acts as a master to validate the request to accept the metrics from the first endpoint and the second endpoint based on the first CA certificate.

In the examples described herein, during the process of a collector group creation, the CA certificate for each collector group may be generated and the generated CA certificate is distributed to the remote collectors in the collector group. Further, a service (e.g., a httpd-south service) at the remote collector may be restarted using the common CA certificate. Also, the certificates may be maintained at the collector group so that they can be retrieved for future purposes.

Further at the endpoint, the application monitoring agent and the supporting agent may use the certificate for communicating with the remote collector. With this implementation, when the collector group is used for application monitoring in case of remote collector failover, the endpoint using the same certificate may be able to connect and post the metrics to the next available remote collector in the collector group.

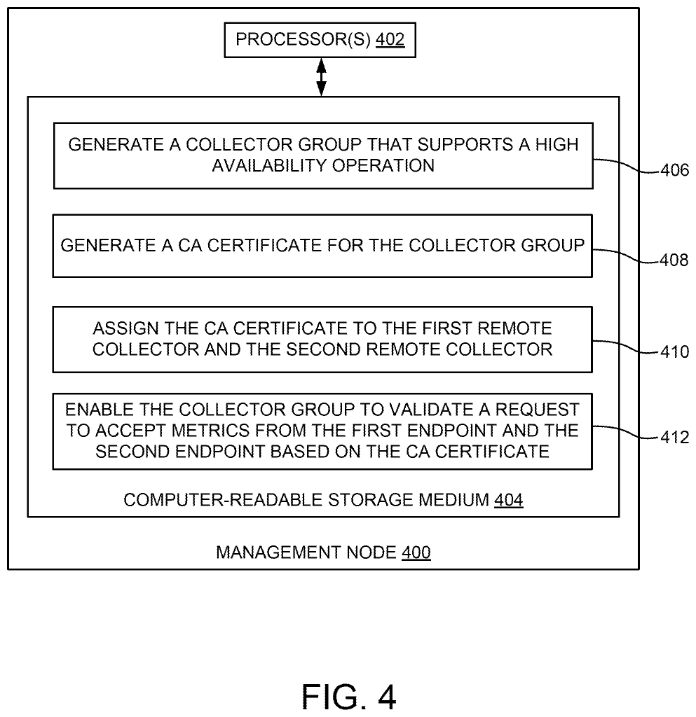

FIG. 4 is a block diagram of an example management node 400 including non-transitory computer-readable storage medium 404 storing instructions to generate a CA certificate for a collector group when a remote collector is added to the collector group. Management node 400 may include a processor 402 and computer-readable storage medium 404 communicatively coupled through a system bus. Processor 402 may be any type of central processing unit (CPU), microprocessor, or processing logic that interprets and executes computer-readable instructions stored in computer-readable storage medium 404. Computer-readable storage medium 404 may be a random-access memory (RAM) or another type of dynamic storage device that may store information and computer-readable instructions that may be executed by processor 402. For example, computer-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 404 may be a non-transitory computer-readable medium. In an example, computer-readable storage medium 404 may be remote but accessible to management node 400.

Computer-readable storage medium 404 may store instructions 406, 408, 410, and 412. Instructions 406 may be executed by processor 402 to generate a collector group that supports a high availability operation. The collector group may include a first remote collector that receives metrics from a first endpoint and a second remote collector that receives metrics from a second endpoint. In an example, the high availability operation may include a load balancing operation in which the metrics from the first endpoint and the second endpoint are distributed among the first remote collector and the second remote collector for load balancing. In another example, the high availability operation may include a failover operation in which, during a failover of the master remote collector, the standby remote collector may be enabled to validate the request to accept the metrics from the first endpoint and the second endpoint using the CA certificate.

Instructions 408 may be executed by processor 402 to generate a certificate authority (CA) certificate for the collector group. Instructions 410 may be executed by processor 402 to assign the CA certificate to the first remote collector and the second remote collector.

Instructions 412 may be executed by processor 402 to enable the collector group to validate a request to accept metrics from the first endpoint and the second endpoint based on the CA certificate. In an example, instructions 412 to enable the collector group to validate the request may include instructions to restart a first service running in the first remote collector using the CA certificate to enable the collector group to validate the request to accept the metrics from the first endpoint and restart a second service running in the second remote collector using the CA certificate to enable the collector group to validate the request to accept the metrics from the second endpoint.

In an example, instructions 412 to enable the collector group to validate the request may include instructions to enable a master remote collector of the collector group to validate the request to accept the metrics from the first endpoint and the second endpoint based on the CA certificate. For example, one of the first remote collector and the second remote collector may act as the master remote collector while a remaining one of the first remote collector and the second remote collector is to act as a standby remote collector.

In an example, instructions 412 to enable the collector group to validate the request comprise instructions to generate a first client certificate and a second client certificate for the first endpoint and the second endpoint, respectively, using the CA certificate of the collector group. Further, the first client certificate and the second client certificate may be assigned to the first endpoint and the second endpoint, respectively. In response to receiving a request to accept the metrics from the first endpoint, the first endpoint may be validated based on the first client certificate and the CA certificate. Further in response to receiving a request to accept the metrics from the second endpoint, the second endpoint may be validated based on the second client certificate and the CA certificate. Furthermore, the collector group may be enabled to accept the metrics from the first endpoint and the second endpoint based on validating the first endpoint and the second endpoint.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a first endpoint;
a second endpoint executing a remote collector to receive metrics from the first endpoint using a first certificate authority (CA) certificate of the remote collector and send the received metrics to a monitoring application;
a storage device to store a second CA certificate for a collector group that shares responsibility for a monitoring function to support high availability; and
a management node comprising a processor executing a certificate management module to:
in response to receiving a request, add the second endpoint to the collector group;
retrieve the second CA certificate from the storage device;
replace the first CA certificate of the remote collector with the second CA certificate of the collector group; and
enable the collector group to validate a request to accept the metrics from the first endpoint based on the second CA certificate.

2. The system of claim 1, wherein the certificate management module is to:
enable one of remote collectors of the collector group that acts as a master to validate the request to accept the metrics from an agent running in the first endpoint based on the second CA certificate.

3. The system of claim 1, wherein the certificate management module is to:
restart a service running in the remote collector using the second CA certificate to enable the collector group to validate the request to accept the metrics from the first endpoint.

4. The system of claim 1, wherein the remote collector comprises:
a cloud proxy to communicate with the monitoring application.

5. The system of claim 1, wherein the monitoring function that supports high availability for the collector group is a high availability failover operation.

6. The system of claim 1, wherein the monitoring function that supports high availability for the collector group is a load balancing operation.

7. The system of claim 1, wherein the second CA certificate of the collector group is used to generate a client certificate for the first endpoint, wherein the client certificate is used by the first endpoint to post the metrics to the collector group.

8. The system of claim 1, wherein each of the first endpoint and the second endpoint comprises a virtual machine, a container, or a physical computing system.

9. A method comprising:
generating a collector group that shares responsibility for a monitoring function to support high availability;
generating a first certificate authority (CA) certificate for the collector group;
receiving a first request to add a first remote collector to the collector group, wherein the first remote collector is to validate a request to accept metrics from a first endpoint based on a second CA certificate; and
in response to receiving the first request,
add the first remote collector to the collector group;
retrieve the first CA certificate associated with the collector group;
replace the second CA certificate of the first remote collector with the retrieved first CA certificate; and
enable the collector group to validate the request to accept the metrics from the first endpoint based on the first CA certificate.

10. The method of claim 9, further comprising:
receiving a second request to add a second remote collector to the collector group, wherein the second remote collector is to validate a request to accept metrics from a second endpoint based on a third CA certificate; and
in response to receiving the second request,
add the second remote collector to the collector group;
retrieve the first CA certificate associated with the collector group;
replace the third CA certificate of the second remote collector with the retrieved first CA certificate; and
enable the collector group to validate a request to accept the metrics from the second endpoint based on the retrieved first CA certificate.

11. The method of claim 10, wherein enabling the collector group to validate the request to accept the metrics from the first endpoint and the second endpoint comprises:
enabling one of the first remote collector and the second remote collector of the collector group that acts as a master to validate the request to accept the metrics from the first endpoint and the second endpoint based on the first CA certificate.

12. The method of claim 9, wherein enabling the collector group to validate the request to accept the metrics from the first endpoint comprises:
restarting a service running in the remote collector using the first CA certificate to enable the collector group to validate the request to accept metrics from the first endpoint.

13. The method of claim 9, wherein the monitoring function that supports high availability for the collector group is a high availability failover operation, a load balancing operation, or a combination thereof.

14. The method of claim 9, further comprising:
generating a client certificate for the first endpoint using the first CA certificate of the collector group, wherein the client certificate is used by the first endpoint to post the metrics to the collector group.

15. A non-transitory computer-readable storage medium storing instructions executable by a processor of a management node to:
generate a collector group that supports a high availability operation, wherein the collector group comprises a first remote collector that receives metrics from a first endpoint and a second remote collector that receives metrics from a second endpoint;
generate a certificate authority (CA) certificate for the collector group;
assign the CA certificate to the first remote collector and the second remote collector; and
enable the collector group to validate a request to accept metrics from the first endpoint and the second endpoint based on the CA certificate.

16. The non-transitory computer-readable storage medium of claim 15, wherein instructions to enable the collector group to validate the request comprise instructions to:
restart a first service running in the first remote collector using the CA certificate to enable the collector group to validate the request to accept the metrics from the first endpoint; and
restart a second service running in the second remote collector using the CA certificate to enable the collector group to validate the request to accept the metrics from the second endpoint.

17. The non-transitory computer-readable storage medium of claim 15, wherein the high availability operation comprises a load balancing operation in which the metrics from the first endpoint and the second endpoint are distributed among the first remote collector and the second remote collector for load balancing.

18. The non-transitory computer-readable storage medium of claim 15, wherein instructions to enable the collector group to validate the request comprise instructions to:
enable a master remote collector of the collector group to validate the request to accept the metrics from the first endpoint and the second endpoint based on the CA certificate, wherein one of the first remote collector and the second remote collector is to act as the master remote collector while a remaining one of the first remote collector and the second remote collector is to act as a standby remote collector.

19. The non-transitory computer-readable storage medium of claim 18, wherein the high availability operation comprises a failover operation in which, during a failover of the master remote collector, enable the standby remote collector to validate the request to accept the metrics from the first endpoint and the second endpoint using the CA certificate.

20. The non-transitory computer-readable storage medium of claim 15, wherein instructions to enable the collector group to validate the request comprise instructions to:
generate a first client certificate and a second client certificate for the first endpoint and the second endpoint, respectively, using the CA certificate of the collector group;
assign the first client certificate and the second client certificate to the first endpoint and the second endpoint, respectively;
in response to receiving a request to accept the metrics from the first endpoint, validate the first endpoint based on the first client certificate and the CA certificate;
in response to receiving a request to accept the metrics from the second endpoint, validate the second endpoint based on the second client certificate and the CA certificate; and
enable the collector group to accept the metrics from the first endpoint and the second endpoint based on validating the first endpoint and the second endpoint.
